(19) United States
(12) Patent Application Publication
(10) Pub. No.: US 2026/0289962 A1
(43) Pub. Date: Sep. 24, 2026

(54) System and method to dynamically reconstruct portions of an electronic screen recording

(71) Applicant: Bank of America Corporation, Charlotte, NC (US)

(72) Inventors: Nipun Mahajan, Lawrenceville, NJ (US); S.B. PRAVIN KUMAR, Nagercoil (IN); Veera Venkata Anand Madhireddy, Hyderabad (IN); Yazhini Chandran, Thalaivasal (IN); Amit Mishra, Chennai (IN); Mrunmai V. Javalgekar, Princeton, NJ (US); Dhiraj Jain, Castaic, CA (US); Yogesh Raghuvanshi, Pennington, NJ (US)

(21) Appl. No.: 19/085,872

(22) Filed: Mar. 20, 2025

(51) Int. Cl. G06V 10/764; G06V 10/75; G06V 20/40; G06V 20/70

(52) U.S. Cl. CPC G06V 10/764; G06V 10/759; G06V 20/41; G06V 20/70; G06V 2201/10

(57) ABSTRACT

A system comprises a memory communicatively coupled to at least one processor. The memory is operably configured to The at least one processor is configured to electronically divide annotated frames into multiple content portions, train an artificial intelligence algorithm based on input data representative of historical data associated with possible static layouts found in an electronic screen and expected dynamic content to be shown in the electronic screen, and arrange, using the trained artificial intelligence algorithm, the annotated frames in in a recording order based on corresponding timestamps. Further, the at least one processor may be configured to, using the trained artificial intelligence algorithm, locate a reference label in the annotated frames matching a query type handled by a workspace device while an electronic recording of the electronic screen was performed and isolate selected portions of the multiple content portions matching the reference label in the annotated frames.

### TECHNICAL FIELD

The present disclosure relates generally to operations associated with performing intelligent recording of an electronic screen, and more specifically to a system and method to dynamically reconstruct portions of an electronic screen recording.

### BACKGROUND

In communication systems, multiple devices may perform communication operations with one another. In certain communication systems, the communication operations may be data exchanges recorded in multiple screens and/or displays. In a same screen, there may be communication operations that relate to multiple different queries, concepts, and/or information types. Conventional systems record the entirety of all information in a screen and/or a display. In communication systems, multiple devices may perform communication operations with one another. In certain communication systems, the communication operations may be data exchanges performed between two or more devices. The communication operations may consume (e.g., use) network resources each time data is exchanged. The network resources may comprise power resources, memory resources, and/or processing resources. Several network resources may be consumed in processes comprising lengthier communication operations lasting multiple minutes. Further, several resources may be consumed in processes comprising larger data exchanges in which multiple information packets are exchanged.

### SUMMARY OF THE DISCLOSURE

In one or more embodiments, a system and method described herein are configured to dynamically reconstruct content portions of an electronic screen recording. In particular, the system may be configured to generate input data sets for an intelligent frame analysis tool based on artificial intelligence (AI)-driven analysis of recordings of chat interactions between workspace devices (e.g., agents) and users. The AI algorithms may be trained to associate workspace device actions to specific topics. Herein, the system is configured to collect some, or all, recorded chat conversations in a database, divide the recordings into individual frames, split the frames in sections with multiple content portions, and annotate these sections with metadata referencing topics and/or queries associated with a situation handled by a workspace device when the chat was recorded. The annotated frames may be parsed through a sensitive data masking engine that masks sensitive information found in the recordings. Then, the system may be configured to annotate each frame using the metadata to indicate a type of sensitive information extracted. These annotated frames are considered the output of the system. Once the annotated frames are processed, these frames are collected in an input set.

Further, the system may be configured to receive the generated input sets with annotated frames and create individual recordings for individual queries identified in the annotated frames. Herein, the system is configured to collect some, or all, the annotated frames in an input set, determine a specific query from a user, determine a sequence of workspace device actions associated with the query in the annotated frames, identify and track workspace device actions across the annotated frames, and match the actions of the workspace device to specific user queries via metadata analysis. The workspace device actions may be evaluated using an AI algorithm trained to determine when a workspace device performs an action in the electronic screen based of a user prompt and/or a user query. The system may be configured to isolate content portions of an image query containing workspace device actions and associate some, or all, workspace device actions with a common query from a common user based on the metadata in the frames. These isolated content portions may be collected in an intelligent recording for the specific query. These intelligent recordings are considered the output of the system. Once the intelligent recordings are generated, some, or all, frames that were not associated with an intelligent recording are collected and labeled as “Auditable Frames,” “Spare Frames,” or “Irrelevant Frames.”

In addition, the system may be configured to dynamically analyze content in as “Auditable Frames,” “Spare Frames,” or “Irrelevant Frames,” generate insights from the contents of these frames, and match content portions of these frames into one or more of the intelligent recordings generated in the second invention. Herein, the system may be configured receive some, or all, as “Auditable Frames,” “Spare Frames,” or “Irrelevant Frames.” and the individual intelligent recordings. The workspace device's actions as shown in the frames and the intelligent recordings are audited to determine workspace device errors. The workspace device errors may be evaluated using an AI algorithm trained to determine when a workspace device backtracks in response to a user query. The system may be configured to generate insights configured to provide explanations to the backtracking of the workspace device. The insights are categorized in accordance with a rule set to separate absolute errors by the workspace device from necessary backtracking performed to complete the user's query. Herein, absolute errors are discarded, and necessary backtracking is matched to a corresponding intelligent recording.

In one or more embodiments, the system and method described herein are integrated into a practical application of dynamically determining intent behind information shared in communication operations and creating virtual elements configured to provide knowledge relating to the intent and/or provide additional insight regarding the intent. In one or more embodiments, the information shared may be processed as data packets exchanged between two or more devices in real time. In this regard, real time may refer to smaller delays (e.g., milliseconds, nanoseconds, and the like) between processing time after the data packets are obtained. The data packets may be transcribed into text data and/or image data. Herein, an artificial intelligence algorithm may be trained to structure the transcribed data in accordance with one or more intent labeling models, determine motivation from the structured version of the transcribed data, and generate one or more intents based at least in part upon the structured version of the transcribed data.

In some embodiments, the system and method are integrated into a practical application of actively determining one or more sections of a display that are associated with a common intent. The system is configured to receive one or more interactions in an electronic screen based on summarized versions of information in the data packets. For example, in an educational setting, the system may be configured to generate one or more summaries based on the contents of a lecture shown in multiple displays. As a presenter (e.g., a professor) describes and/or shows information relating to one or more elements of a subject, the system may be configured to separate information shown in the multiple displays into content portions, electronically label the content portions in association with their corresponding topic and associate the content portions with one another based on the similarities of an intent based on the content. The intent may be determined based on key points and/or key words within the content. To obtain these key points and/or key words, the trained artificial intelligence algorithm is used to summarize the information in the content portions into one or more key points and/or key words. Then, the system may be configured to determine, upon executing the trained artificial intelligence algorithm, an appropriate label of the key points based on the content of each key-point irrespective of the format of the content (e.g., charts, graphs, drawings, and the like). The system may be configured to determine actions associated with the content (e.g., image display, audio from the presentation, and the like), electronically extract some, or all, related content and any determined actions, and bind the extracted content and actions into a single representation of the information.

In conventional recording systems, recording of an electronic screen includes all information shown in the electronic screen. For a workspace device handling multiple interactions with multiple user devices in multiple displays, conventional systems record all interactions in a given display. This approach causes related interactions in other displays to be dropped and/or unaccounted. In this regard, conventional systems fail to: 1) provide any cohesive recordings corresponding to interactions with a same user device when the interactions are performed using multiple applications on multiple displays; 2) distinguish between interactions among multiple user devices about a same topic; and 3) prevent private information associated with the user devices from being recorded.

In one or more embodiments, the systems are directed to technical solutions configured to solve technical problems. In particular, the system provides technical solutions to overcome the deficiencies 1)-3) described above with respect to conventional systems. In this regard, the system provides technical solutions in the field of image analysis and segmentation.

With regards to 1) and 2), the system provides intelligent recordings comprising interactions performed in multiple displays and/or multiple applications associated with a single user device. In this regard, the system is configured to record and package all information shown in display devices and/or hardware available to a workspace device. Data packets in the packaged recording are evaluated frame-by-frame and each frame is electronically divided into content portions. The content portions are evaluated against one another to limit the portion in which the division stops within the frame. For example, content in a frame may be segmented into two content portions comprising content in a first application and content in a second application. Further, electronically divided portions are labeled in association with the corresponding content, a query, and a user device associated with the query. Then, the content portions are matched to one another in accordance with the labels. The content portions are maintained in an updated version of the packaged recording. As a result, the system described herein provides improvements in the field of image analysis and segmentation because the system overcomes, inhibits, and/or eliminates the deficiencies described in 1) and 2) with respect to conventional systems.

With regards to 3), the system inhibits personal (e.g., sensitive) information from being included in recording and/or recorded data. In this regard, the system is configured to dynamically track queries generated based on interactions between a workspace device and a user device and determines sensitive information and/or personal data in the display. Herein, the system is configured to generate collected recorded data for packaging while removing the determined sensitive data. By preventing sensitive data from being included in the packaged recording, the system prevents personal and/or sensitive information from being copied, shared, and/or distributed along any data packets and/or recorded image frames. As a result, the system described herein provides improvements in the field of image analysis and segmentation because the system overcomes, inhibits, and/or eliminates the deficiencies described in 3) with respect to conventional systems.

In one or more embodiments, the system is configured to provide an intelligent screen recording system. Currently, an agent may handle communication queries and/or issues from multiple users at a same time. In the agent's electronic screen setup, the agent may open, close, and/or modify content associated with one or more of the communication queries. While agents may be efficient in handling communication queries, approaches followed by conventional systems may cause standard electronic screen recordings to be useless as the recordings collect all elements shown and/or performed by the agent in association with all queries that the agent handled over a period of time. Contrary to conventional systems, the intelligent recording system described herein is configured to dynamically match queries from users with specific actions in the agent's electronic screens. In this regard, the system is configured to generate input sets that the intelligent screen recording system needs to operate; perform image partitioning and correlation to create an intelligent recording that only includes content associated with a specific query; and resolve outstanding frames that were not properly categorized by the second invention (e.g., in cases where an agent is handling similar queries for two different users at a same time).

In one or more embodiments, the systems and the methods may be performed by an apparatus, such as a server. Further, the system may be a data exchange system, which comprises the apparatus. In addition, the system and the method may be performed as part of a process performed by the apparatus. As a non-limiting example, the apparatus may comprise a memory and a processor communicatively coupled to one another. The memory may be operable to store multiple annotated frames corresponding to an electronic recording of an electronic screen associated with a workspace device and at least one artificial intelligence algorithm configured to dynamically reconstruct content portions of an electronic screen recording. The annotated frames may comprise a first annotated frame, a second annotated frame, and a third annotated frame. The first annotated frame comprises a first timestamp, multiple first content portions, and first metadata. The second annotated frame comprises a second timestamp, multiple second content portions, and second metadata. The third annotated frame comprises a third timestamp, multiple third content portions, and third metadata.

The processor may be configured to electronically divide the first annotated frame into the multiple first content portions, the multiple second annotated frame into the second content portions, and the third annotated frame into the multiple third content portions, and electronically extract multiple first labels from the first metadata, multiple second labels from the second metadata, and multiple third labels from the third metadata. Each of the multiple first labels corresponding to one of the first content portions. Each of the multiple second labels corresponding to one of the second plurality of content portions. Each of the multiple third labels corresponding to one of the third plurality of content portions. Further, the processor may be configured to train the artificial intelligence algorithm based at least in part upon input data representative of historical data associated with possible static layouts found in the electronic screen and expected dynamic content to be shown in the electronic screen and arrange, using the trained artificial intelligence algorithm, the first annotated frame, the second annotated frame, and the third annotated frame in in a recording order based on the first timestamp, the second timestamp, and the third timestamp.

In addition, the processor may be configured to, using the trained artificial intelligence algorithm, locate a reference label in the multiple first labels, the multiple second labels, and the multiple third labels matching a query type handled by the workspace device while the electronic recording of the electronic screen was performed and isolate a first selected portion of the multiple first content portions matching the reference label in the first annotated frame, a second selected portion of the multiple second content portions matching the reference label in the second annotated frame, and a third selected portion of the multiple third content portions matching the reference label in the third annotated frame.

The processor may be configured to, using the trained artificial intelligence algorithm, electronically separate the first selected portion from the multiple first content portions, the second selected portion from the multiple second content portions, and the third selected portion from the multiple third content portions and create multiple tracking parameters configured to track content changes in the first selected portion, the second selected portion, and the third selected portion based on the query type. Further, the processor may be configured to track, in conjunction with the plurality of tracking parameters, a first content change between the first selected portion and the second selected portion and a second content change from the second selected portion to the third selected portion.

The processor may be configured to, using the trained artificial intelligence algorithm, derive a first intent associated with the first content change and a second intent associated with the second content change, determine whether the first intent logically matches the query type, determine whether the second intent logically matches the query type in response to determining that the first intent logically matches the query type, and create an intelligent recording comprising the first selected portion, the second selected portion, and the third selected portion in response to determining that the second intent logically matches the query type.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a system in accordance with one or more embodiments;

FIG. 2 illustrates an operational flow configured to dynamically reconstruct content portions of an electronic screen recording performed by the system in FIG. 1 in accordance with one or more embodiments; and

FIGS. 3A and 3B illustrate an example flowchart of a method to dynamically reconstruct content portions of an electronic screen recording following the operational flow of FIG. 2 in accordance with one or more embodiments.

### DETAILED DESCRIPTION

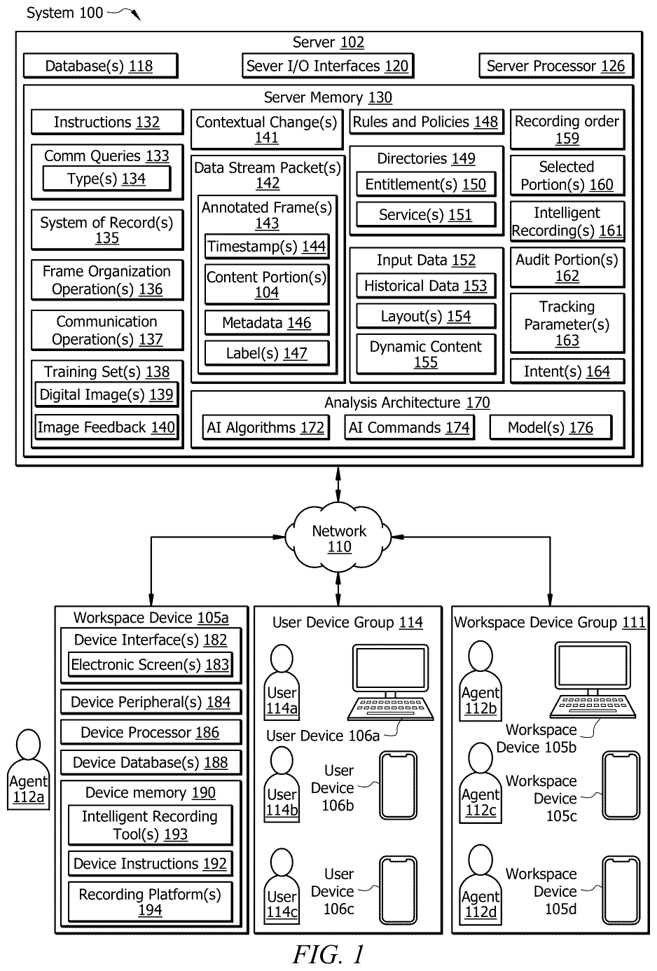

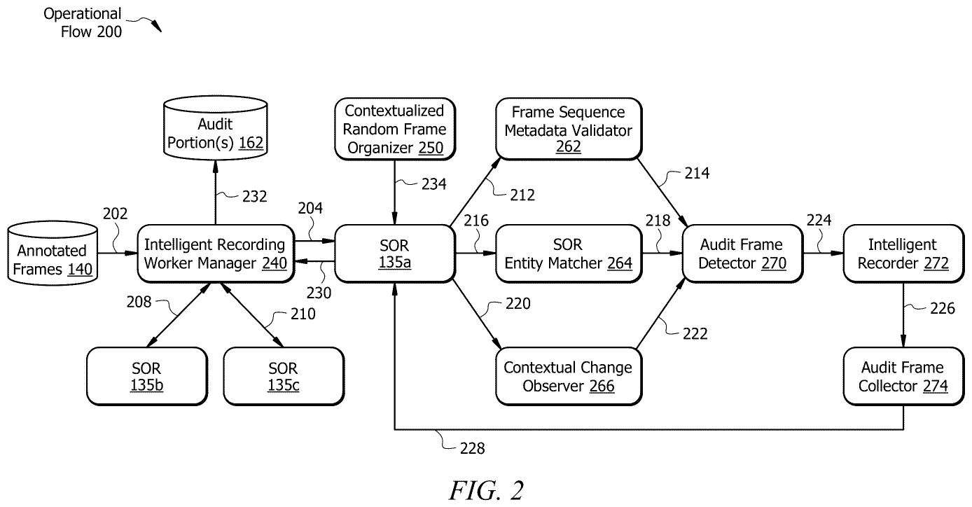

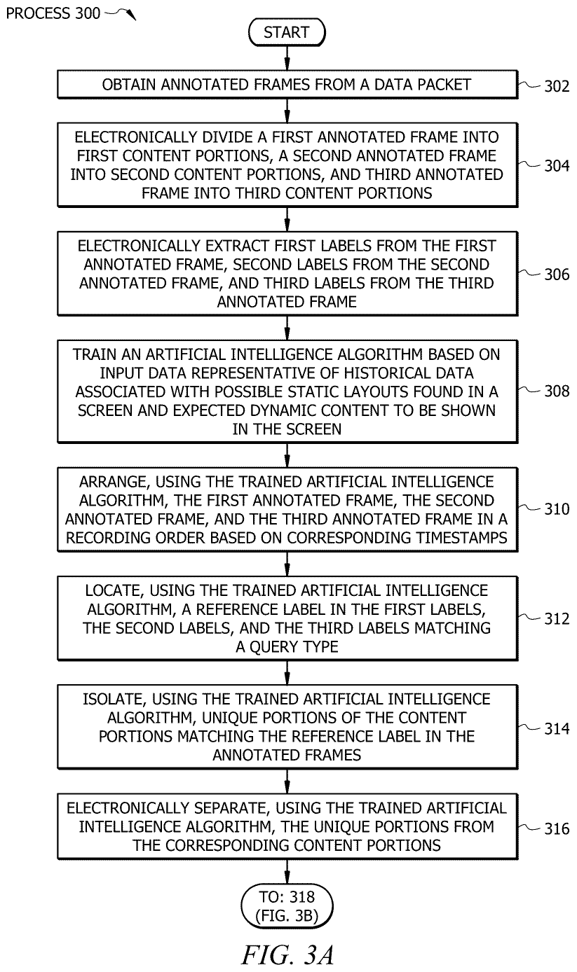

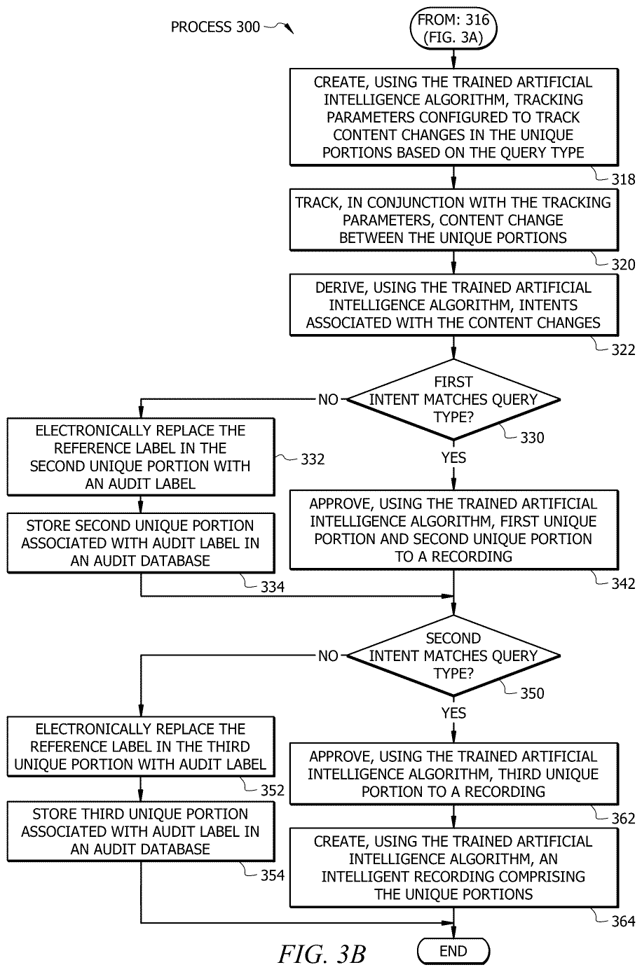

As described above, this disclosure provides various systems and methods to dynamically reconstruct content portions of an electronic screen recording. FIG. 1 illustrates a system 100 in which a server 102 is configured to dynamically reconstruct content portions 104 of an electronic screen recording. FIG. 2 illustrates an operational flow 200 performed by the system 100 of FIG. 1. FIGS. 3A and 3B illustrate a process 300 performed by the system 100 of FIG. 1.

### System Overview

FIG. 1 illustrates an example system 100, in accordance with one or more embodiments. The system 100 may comprise a server 102 configured to perform one or more reconstruction operations. In the system 100 of FIG. 1, the server 102 is communicatively coupled to multiple workspace devices 105a-105d (collectively, workspace devices 105) and multiple user devices 106a-106c (collectively, user devices 106) via a network 110. In some embodiments, the workspace device 105a is a standalone device, while the workspace device 105b, the workspace device 105c, and the workspace device 105d may be incorporated in a workspace device group 111. Each of the workspace device 105a, the workspace device 105b, the workspace device 105c, and the workspace device 105d may be operated by an agent 112a, an agent 112b, an agent 112c, and an agent 112d, respectively. The workspace device group 111 may comprise less or more workspace devices 105 than those shown in FIG. 1. Further, the user device 106a, the user device 106b, and the user device 106c may be incorporated in a user device group 113. Each of the user device 106a, the user device 106b, and the user device 106c may be operated by a user 114a, a user 114b, and a user 114c, respectively. The user device groups 113 may comprise less or more user devices 106 than those shown in FIG. 1.

In one or more embodiments, the server 102 comprises the databases 118, a server input (I)/output (O) interfaces 120, at least one server processor 126 comprising a processing engine (not shown), and a server memory 130. In some embodiments, the databases 118 may be standalone memory storage units or part of the server memory 130. In some embodiments, the server memory 130 may be operable to store instructions 132, one or more communication queries 133 comprising one or more query types 134, one or more system of records (SORs) 135, one or more frame organization operations 136, one or more communication operations 137, and one or more training sets 138 comprising one or more digital images 139 and image feedback 140. Further, the server memory 130 may be operable to store one or more contextual changes 141, one or more data stream packets 142 comprising one or more annotated frames 143 comprising one or more timestamps 144, one or more content portions 104, metadata 146 associated with the annotated frames 143, and one or more labels 147, one or more rules and policies 148, and one or more directories 149 comprising one or more entitlements 150 and one or more services 151. The server memory 130 may be operable to store input data 152 comprising historical data 153, one or more layouts 154, and dynamic content 155, at least one recording order 159, one or more selected portions 160, one or more intelligent recordings 161, one or more audit portions 162, the tracking parameters 163, the intents 164, and at least one analysis architecture 170 comprising one or more AI algorithms 172, one or more AI commands 174, and one or more models 176.

Referring to the workspace device 105a as a non-limiting example of the workspace devices 105, the workspace devices 105 may comprise one or more device interfaces 182, one or more device peripherals 184, a device processor 186, one or more device databases 188, and a device memory 190. The device memory 190 may comprise multiple device instructions 192, multiple intelligent recording tools 193, and one or more recording platforms 194. The user devices 106 may comprise one or more elements and/or components described in reference to the workspace device 105a.

### System Components

### Server

The server 102 is generally any device or apparatus that is configured to process data and communicate with computing devices (e.g., the workspace devices 105 and/or the user devices 106), additional databases, systems, and the like, via the one or more server I/O interfaces 120 (i.e., a user interface or a network interface). The server 102 may comprise the server processor 126 that is generally configured to oversee operations of the processing engine. The operations of the processing engine are described further below in conjunction with the system 100 described in FIG. 1, the operation flow 200 described in FIG. 2, and the process 300 described in FIGS. 3A and 3B.

The server 102 comprises multiple databases 118 configured to provide one or more memory resources to the server 102, the workspace devices 105, and/or and the user devices 106. The server 102 comprises the server processor 126 communicatively coupled with the databases 118, the server I/O interfaces 120, and the server memory 130. The server 102 may be configured as shown, or in any other configuration. In one or more embodiments, the databases 118 are configured to store data that enables the server 102 to configure, manage and coordinate one or more middleware systems. In some embodiments, the databases 118 store data used by the server 102 to function as a halfway point in between applications and other tools or databases.

In one or more embodiments, the databases 118 may be one of the server databases in one of the managed servers. In one example, the server 102 may determine the server processor 126 is available (e.g., running) to perform a specific server application (e.g., service). In another example, the server 102 may determine that a specific managed server is running to perform a specific server application after receiving a server response indicating that a corresponding managed server is available to perform the server application. In one or more embodiments, the server 102 may determine whether a specific device processor 186 is available (e.g., running) to perform one or more specific local applications. In yet another example, the server 102 may determine that the databases 118 are running to provide memory resources to execute server applications receiving a database response indicating that the databases 118 are available to provide memory resources to execute the server applications. In one or more embodiments, the server 102 may determine whether the databases 118 are available (e.g., running) and may provide the database response. In one or more embodiments, one of the managed servers may determine whether the corresponding databases 118 are available (e.g., running) and may provide the database response.

In one or more embodiments, the server I/O interfaces 120 may be configured to enable wired and/or wireless communications. The server I/O interfaces 120 may be configured to communicate data between the server 102 and other devices (i.e., the workspace devices 105 and/or the user devices 106), network devices (i.e., routers in the network 110), systems, or domain(s) via the network 110. For example, the server I/O interfaces 120 may comprise a wireless fidelity (WI-FI) interface, a local area network (LAN) interface, a wide area network (WAN) interface, a modem, a switch, or a router. The server processor 126 may be configured to send and receive data using the server I/O interfaces 120. The server I/O interfaces 120 may be configured to use any suitable type of communication protocol. In some embodiments, the server I/O interfaces 120 may be an admin console comprising a display configured to show a user interface used to manage a middleware server domain via the server 102. A middleware server domain may be a logically related group of workspace devices 105 that are managed as a unit. A middleware server domain may comprise the server 102 and one or more workspace devices 105. The workspace devices 105 may be standalone devices and/or collected devices in a workspace device group 111. The workspace device group 111 may be a group of managed workspace devices 105 that work together to provide scalability and higher availability for server and/or workspace applications. In this regard, the server and/or workspace applications may be provisioned and deployed as part of at least one domain. In other embodiments, one instance of the workspace devices 105 in the middleware server domain may be configured as the server 102. The server 102 provides a central point for managing and configure the workspace devices 105, any of the one or more server and/or workspace applications.

The at least one server processor 126 may comprise one or more processors communicatively coupled to the server memory 130. The server processor 126 may be any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The server processor 126 may be a programmable logic device, a microcontroller, a microprocessor, or any suitable combination of the preceding. The one or more server processors 126 may be configured to process data and may be implemented in hardware or software executed by hardware. For example, the server processor 126 may be 8-bit, 16-bit, 32-bit, 64-bit or of any other suitable architecture. The server processor 126 may include an arithmetic logic unit (ALU) for performing arithmetic and logic operations, processor registers that supply operands to the ALU and store the results of ALU operations, and a control unit that fetches the instructions 132 from the server memory 130 and executes them by directing the coordinated operations of the ALU, registers and other components. In this regard, the one or more server processors 126 are configured to execute various instructions. For example, the one or more server processors 126 are configured to execute the instructions 132 to implement the functions disclosed herein, such as some or all of those described with respect to FIGS. 1-3B. In some embodiments, the functions described herein are implemented using logic units, FPGAs, ASICs, DSPs, or any other suitable hardware or electronic circuitry.

In one or more embodiments, the server I/O interfaces 120 may be any suitable hardware and/or software to facilitate any suitable type of wireless and/or wired connection. These connections may include, but not be limited to, all or a portion of network connections coupled to the Internet, an Intranet, a private network, a public network, a peer-to-peer network, the public switched telephone network, a cellular network, a local area network (LAN), a metropolitan area network (MAN), a wide area network (WAN), and a satellite network. The server I/O interfaces 120 may be configured to support any suitable type of communication protocol as would be appreciated by one of ordinary skill in the art.

The server memory 130 may be volatile or non-volatile and may comprise a read-only memory (ROM), random-access memory (RAM), ternary content-addressable memory (TCAM), dynamic random-access memory (DRAM), and static random-access memory (SRAM). The server memory 130 may be implemented using one or more disks, tape drives, solid-state drives, and/or the like. The server memory 130 may be operable to store the instructions 132, the one or more communication queries 133 comprising the one or more query types 134, the one or more system of records (SORs) 135, the one or more frame organization operations 136, the one or more communication operations 137, and the one or more training sets 138 comprising the one or more digital images 139 and the image feedback 140. Further, the server memory 130 may be operable to store the one or more contextual changes 141, the one or more data stream packets 142 comprising the one or more annotated frames 143 comprising the one or more timestamps 144, the one or more content portions 104, the metadata 146 associated with the annotated frames 143, and the one or more labels 147, the one or more rules and policies 148, and the one or more directories 149 comprising the one or more entitlements 150 and the one or more services 151. The server memory 130 may be operable to store the input data 152 comprising the historical data 153, the one or more layouts 154, and the dynamic content 155, the at least one recording order 159, the one or more selected portions 160, the one or more intelligent recordings 161, the one or more audit portions 162, the tracking parameters 163, the intents 164, and the at least one analysis architecture 170 comprising the one or more AI algorithms 172, the one or more AI commands 174, the one or more models 176, and/or any other data or instructions. The instructions 132 may comprise any suitable set of instructions, logic, rules, or code operable to execute the server processor 126.

The communication queries 133 may be one or more queries determined and/or identified in association with one or more communication operations 137 between the server 102, one or more of the workspace devices 105, and/or the user devices 106. The communication queries 133 may comprise one or more key points and/or key words that reference operations that triggered and/or started a given communication operation 137. Key points and/or key words may be searched in content exchanged in the communication operations 137 to determine specific query types 134 in exchanged information between the server 102, one or more of the workspace devices 105, and/or the user devices 106. The query types 134 may indicate and/or reference one or more aspect of the communication operations 137. The query types 134 may relate one or more tasks, goals, and/or resources associated with specific performance and/or operations in the server 102, the workspace devices 105, and/or the user devices 106. The query types 134 may be: administrative queries where user devices 106 request provisioning and/or reprovisioning of application configurations from a given workspace device 105; performance queries where the user devices 106 are evaluated against performance targets to determine operation capabilities in one or more portions of the user devices 106; and information queries where the user devices 106 request specific access to one or more databases 118 and/or device databases 188.

The system of records (SORs) 135 may be one or more information control and/or management systems. The SORs 135 may be configured to transform formats of data to perform specific storage functions, one or more communication routings, and/or one or more data analysis to manage sorting of data in the one or more databases 118 and/or device databases 188. The SORs 135 may be configured to provide one or more standardized storage and/or management protocols across multiple locations. There may be one or more SORs 135 associated with a specific user device 106.

The one or more communication operations 137 may be one or more data exchanges performed between two or more network devices in the system 100. The network devices may comprise the server 102, one or more of the workspace devices 105, and one or more of the user devices 106, among others. In one or more embodiments, the communication operations 137 may be audio communications exchanged as part of audio conversations (e.g., during a telephonic call) between two or more network devices. The communication operations 137 may be image and/or text communications exchanged as part of image-based conversations (e.g., during videocalls and/or chat exchanges) between two or more network devices.

The frame organization operations 136 may be one or more operations to transcribe audio data into image data and/or text data. The audio data may be obtained from audio signaling exchanges between network devices in the system 100. The audio data may be an audio signature representative of one or more speech patterns and/or human sounds comprising a frequency range of 10 Hertz (Hz) to 30 kilohertz (kHz), inclusive. The audio data may be any sound exchanged between two or more network devices. In one or more embodiments, the image data may be codified images comprising one or more machine-readable codes representative of the audio data. The text data may be letters and/or numbers. In one or more embodiments, the frame organization operations 136 may be performed as part of one or more speech-to-text operations in real time as sounds are shared between two or more network devices. For example, the server 102 may be configured to transcribe audio data exchanged between one of the workspace devices 105 (e.g., the workplace device 105a) and one of the user devices 106 (e.g., the user device 106a) in real time and/or near-real time.

The frame organization operations 136 may be one or more operations to transcribe image data into text data. The image data may be one or more frames associated with a recording, still images, and/or a combination of both. The image data may comprise chat screenshots, image shared as part of service operations, and/or image obtained from one or more application operations. The text data may be letters and/or numbers. In one or more embodiments, the frame organization operations 136 may be performed as part of one or more image-to-text operations in real time as images are shared between two or more network devices. The frame organization operations 136 may comprise translating image data to text data using an optical character recognition (OCR) tool. For example, the server 102 may be configured to transcribe image data exchanged between one of the workspace devices 105 (e.g., the workplace device 105a) and one of the user devices 106 (e.g., the user device 106a) in real time and/or near-real time.

In one or more embodiments, the server 102 may be configured to identify a communication operation 137 in which audio streams and/or image streams are exchanged between the server 102, one of the workspace devices 105 (e.g., the workplace device 105a), and one of the user devices 106 (e.g., the user device 106a). Herein, the server 102 may be configured to determine audio data in the audio stream, image data in the image stream, and dynamically transcribe the audio data into image data and/or text data and/or image data into text data. The frame organization operations 136 may be performed after executing one or more AI algorithms 172 and one or more AI commands 174 trained to create one or more AI models 176 in an analysis architecture. In turn, the transcribed data may be provided to an intelligent conversation hub (ICH) configured to structure and analyze the transcribed data. In some embodiments, the transcribed data may be a transcript showing lines of text or any other suitable combination of images and/or text. The ICH may be a conversation management framework that considers information in the directories 149 in accordance with a natural language understanding system to determine intent 164 behind a user 114a associated with a user device 106a.

In one or more embodiments, the server 102 may be configured to execute the AI algorithm 172 to generate one or more summaries based on the image data and/or the text data. The summaries may be one or more brief call purpose summaries indicating motivation behind statements in the audio data. The summaries may be evaluated in accordance with a classification model to determine an intent 164 related to statements in the audio data and/or the image data. The image data and/or the text data may be analyzed in accordance a language model to perform one or more summarization processes. In some embodiments, each of the summaries may be a request summary in text data. The request summary may be representative of a predicted purpose behind a specific communication operation 137 associated with the audio data. The summaries may be representative of predicted intents 164 associated with the audio data and/or the image data. The summaries may be representative of one or more intents 164 to perform a specific communication operation 137. The summaries may comprise one or more action items to be performed to at least partially fulfill the intent 164 associated with the audio data and/or the image data.

The training sets 138 may be one or more training data sets configured to provide training information and/or input training data to one or more AI algorithms 172. In some embodiments, the training sets 138 may comprise information associated with one or more operations performed in the system 100. The training sets 138 may be configured to inform and/or predict possible intents 164 in the system 100. The training sets 138 may be configured to comprise one or more digital images 139 and/or image feedback 140. The training sets 138 may be one or more sets of data comprising examples of fames previously determined to be added to intelligent recordings 161. The digital images 139 may be one or more images of annotated frames 143 including specific content portions 104 and/or one or more selected portions 160. The digital images 139 may be examples of selected portions 160 determined to be relevant as part of intelligent recordings 161. The digital images 139 may be examples of selected portions 160 determined to not be relevant as part of intelligent recordings 161. The image feedback 140 may be positive feedback and/or negative feedback. The positive feedback may be image feedback 140 including digital images 139 that are previously determined to be related to intelligent recordings 161 and/or one or more audit portions 162. The negative feedback may be image feedback 140 including digital images 139 that are previously determined to be unrelated to intelligent recordings 161 and/or one or more audit portions 162. The digital images 139 in the training sets 138 may be representative of static images modified to cover multiple current and/or possible appearances in electronic screen recordings. For example, an image of a chat box may be modified by distorting tools, blurring tools, and/or down sampling tools to change the appearance of the image into multiple possible versions. Then, the versions and the original image may be used to generate a training set 138.

In some embodiments, the training sets 138 may comprise a transformed version of a set of digital images 139 and a set of content images representing the historical data 153 associated with previous communication queries 133 handled by the workspace device 105a. The set of digital images 139 may be collected from a database. The set of digital images 139 may comprise layout elements expected to be found in an electronic screen 183 during a recording session. The digital images 139 may be transformed in accordance with at least one randomized condition. The at least one randomized condition may be a distortion to the images, an obfuscating of the images, a up sampling of the images, and the like. The training set 138 may comprise one or more previous training sets and one or more sets of digital contentless images representing the historical data 153 associated with previously incorrect queries handled by the workspace device 105a. The contentless images may be content portions 104 comprising blank screenshots.

The contextual changes 141 may be one or more changes and/or modifications in transitions between multiple selected portions 160. The contextual changes 141 may be logical transitions between two consecutive frames as determined by a trained AI algorithm 172. The contextual changes 141 may be based on context changes in content associated with one or more portions of annotated frames 143. For example, first content in a first selected portion 160 may comprise a birthday cake and a first person getting ready to cut the birthday cake. Further second content in a second selected portion 160 may comprise a second person looking at a cupcake. Third content in a third selected portion 160 may comprise the first person cutting the birthday cake. In this example, based on context analysis using the trained AI algorithm 172, the server 102 may be configured to determine that the second selected portion 160 does not represent a logical transition from the first selected portion 160. Herein, several key points and/or key words (e.g., the cupcake versus the birthday cake) in the second selected portion 160 may be unrelated to the first selected portion 160 based on one or more contextual changes 141. Further, based on context analysis using the trained AI algorithm 172, the server 102 may be configured to determine that the third selected portion 160 represents a logical transition from the first selected portion 160. Herein, several key points and/or key words (e.g., transitioning from getting ready to cut the birthday cake to cutting the same birthday cake) in the third selected portion 160 may be related to the first selected portion 160 based on one or more contextual changes 141. In this example, the trained AI algorithm 172 may be configured to assign the first selected portion 160 and the third selected portion 160 to an intelligent recording 161 and relabel the second selected portion 160 as an audit portion 162.

The data stream packets 142 may be one or more packets of information. The data stream packets 142 may comprise information in the form of image data. The data stream packets 142 may be obtained from training materials provided to, or obtained by, the server 102. The data stream packets 142 may comprise one or more annotated frames 143. Each of the annotated frames 143 may comprise a timestamp 144, one or more content portions 104, metadata 146, and one or more labels 147. The annotated frames 143 may be images from an electronic screen recording configured to provide a sequence that forms a video. The annotated frames 143 may be annotated images including the timestamp 144, the metadata 146 and multiple labels 147 corresponding to the content portions 104. The timestamps 144 may reference a date and/or a time in which information is collected. The timestamps 144 may reference when a frame was collected by a sensor and/or electronic screen recording tool. The timestamps 144 may reference when a frame was annotated. The content portions 104 may be one or more pixels and/or groups of pixels representative of a specific point of interest, one or more shapes, and/or one or more words in an image.

The metadata 146 may be data that provides information about other data. In some embodiments, the metadata 146 may be representative of contextual information associated with the one or more images. The metadata 146 may comprise descriptive information about a resource, such as title, abstract, author, and/or related keywords. The metadata 146 may comprise contextual information about containers of data and indicates how compound objects are put together comprising data types, data versions, data relationships, and other data characteristics of digital materials. The metadata 146 may comprise information to help manage a resource, such as a resource type, resource permissions, and/or creation data. The metadata 146 may comprise information about contents and quality of statistical data. The metadata 146 may comprise process data associated with collection, processing, and/or production of statistical data. The labels 147 may be comprised in the metadata 146 to reference a source of the images, annotations in the content portions 104, and/or one or more content elements in the content portions 104. The labels 147 may be comprised in the metadata 146 to reference one or more IDs and/or signatures associated with a source of the data stream packets 142. The labels 147 may be one or more aspects of the data configured to authenticate aspects of the data (e.g., verifying precedence of the data).

The rules and policies 148 may be security configuration commands or regulatory operations predefined by an organization or one or more users 114. In one or more embodiments, the rules and policies 148 may be dynamically defined by the one or more users 114. The rules and policies 148 may be prioritization rules configured to instruct the server 102, the one or more user devices 106, and/or the one or more workspace devices 105 to perform one or more audio analysis operations or perform one or more communication operations 137 in the system 100. The one or more rules and policies 148 may be predetermined or dynamically assigned by a corresponding user 114, a corresponding agent 112, and/or an organization associated with the users 114 and/or the agents 112.

The directories 149 may comprise the one or more user profiles and/or agent profiles, one or more entitlements 150 and one or more services 151. In one or more embodiments, the user profiles and/or agent profiles may comprise multiple profiles associated with one or more entitlements 150 to access and/or modify the services 151. Each of the user profiles and/or agent profiles may be associated with one or more entitlements 150. The entitlements 150 may indicate that a given user device 106 is allowed to access one or more network resources in accordance with the one or more rules and policies 148. The entitlements 150 may indicate that a given user device 106 is allowed to perform one or more operations in the system 100 (e.g., provide a specific application data access to one of the users 114). To secure or protect operations of the user devices 106 from bad actors, the entitlements 150 may be assigned to a given user profile and/or agent profiles in accordance with updated security information, which may provide guidance parameters to the use of the entitlements 150 based at least upon corresponding rules and policies 148. In one or more embodiments, the one or more services 151 are access to one or more application operations performed in accordance with the application data. In some embodiments, the user profiles and/or agent profiles may comprise multiple profiles for users (e.g., user 114). Each user profile and/or agent profiles may comprise one or more entitlements 150. As described above, the entitlements 150 may indicate that a given user 114 is allowed to access one or more network resources in accordance with one or more rules and policies 148. The entitlements 150 may indicate that a given user is allowed to perform one or more data exchanges in the system 100. In one or more embodiments, each of the user profiles and/or agent profiles may comprise information about at least one user 114 entitled to trigger one or more data exchange operations and/or communication operations 137.

In one or more embodiments, the audio data received from a user device 106 may be handled by a voice gateway configured to forward audio streams to a speech-to-text model. The speech-to-text model may be an AI model 176 configured to filter out background noise in an audio stream and identify human speech and execute a trained AI algorithm 172 to transcribe the audio data associated with the human speech. The transcribed version of the audio data may be image data and/or text data. Further, the image data received from a user device 106 may be handled by an SOR 135 configured to manage and/or control image data streams using an image-to-text model. The image-to-text model may be an AI model 176 configured to filter out background noise in an image stream and/or a video stream and execute a trained AI algorithm 172 to transcribe the image data associated with the communication operations 137. The transcribed version of the image data may be text data. At this stage, the AI algorithm 172 may be executed in accordance with a call purpose summarization model to summarize the transcribed data and generate one or more summaries as a result. The AI algorithms 172 may be executed in accordance with a classification model to determine information and/or communication categories associated with the audio data and/or image data. The AI algorithms 172 may be configurated to evaluate the summaries in accordance with a dedicated model to extract entities (e.g., names, dates, accounts, amounts, numbers, and the like) from the summaries.

In one or more embodiments, the server 102 is configured to identify one or more communication operations 137, determine audio data and/or image data in the communication operations 137, and generate one or more summaries based on the audio data and/or image data. The summaries may be configured to represent a purpose behind the audio data and/or image data. As the communication operations 137 continue, subsequent audio data and/or image data is used to generate additional summaries. For each of the summaries, the server 102 may be configured to determine one or more intents 164 from at least a portion of the communication operations 137. As the summaries are obtained, additional intents 164 may be determined over time. As each of the intents 164 are determined, the server 102 may be configured to evaluate each of the intents 164 to identify potential action item suggestions with respect to a starting point (e.g., a starting intent). At a time when the server 102 starts obtaining the audio data and/or image data, a first intent 164 associated with a first action item may be the starting point.

The input data 152 may be one or more data elements and/or data records configured to provide one or more input training for the one or more AI algorithms 172. The historical data 153 may be historic information associated with one or more user devices 106 in a communication network comprising several communication sites. The historical data 153 may comprise one or more reference datapoints representing one or more trends associated with communication operations 137 and/or intelligent recordings 161 associated with a specific user device 106, a group of user devices 106, and/or several user devices 106 associated with one or more device profiles in the communication network. The historical data 153 may be feedback data that is previously processed and determined to match device information associated with one or more device profiles. The reference datapoints may be one or more datapoints that are previously processed and determined to match device information associated with one or more device profiles. The layouts 154 may be combination of static image portions that are expected to be included in electronic screen 183 recordings. For example, a layout 154 may be one or more images for the contours and/or corners of an image presentation, website, and/or forms which may be shown in an electronic screen 183 associated with a given workspace device 105. The dynamic content 155 may be one or more expected images shown in an electronic screen 183. The dynamic content 155 may be representative of one or more modifications, changes, and/or alterations to image data shown in one or more of the device interfaces 182 (e.g., an electronic screen 183).

The recording order 159 may be a combination of timelines configured to reference an order in which images are captured, processed, and/or communicated. The recording order 159 may be assigned based on the timestamps 144. The selected portions 160 may be one or more of the content portions 104 that are determined to be selected in a given annotated frame 143 based on a specific reference label 147. There may be one or more content portions 104 that are determined to include a specific reference label 147.

The intelligent recordings 161 may be one or more reconstructed recordings based on one or more content portions 104 from the annotated frames 143. The intelligent recordings 161 may comprised one or more of the selected portions 160 organized in a recording order 159. The intelligent recordings 161 may comprise selected portions 160 that are determined to be logically related to one another based on corresponding contextual changes 141.

The audit portions 162 may be one or more selected portions 160 that are determined to be logically unrelated to one another based on corresponding contextual changes 141. The audit portions 162 may be determined to include one or more sequential anomalies found in a set of selected portions 160. The sequential anomalies may be one or more abnormal, peculiar, and/or unexpected aspects of a contextual change 141 between the selected portions 160 in the set of selected portions 160. The sequential anomalies may be one or more deviations in an expected image and/or a specific content portion 104 of an image. For example, a sequential anomaly in an image may be a shape with a different color than a color that is expected. In another example, a sequential anomaly in an image may be a word with different text characters than the text characters that are expected.

The tracking parameters 163 may be one or more image indicators configured to track content changes in the content portions 104 and/or the selected portions 160 based on the a given condition. The given condition may be a specific query type 134, an association with a specific user device 106 and/or an association with a specific service 151.

In one or more embodiments, the intents 164 may be one or more target operations that are expected to be performed as part of one or more data exchange operations and/or one or more communication operations 137 performed in the communication network. The server 102 may be configured to generate one or more suggestions comprising action items to perform, start, trigger, and/or complete the target operations. In some embodiments, the server 102 may be configured to evaluate a sequence of target operations and determine subsequent intents 164 based on the sequence of target operations.

In one or more embodiments, the analysis architecture 170 comprises the AI algorithms 172, the AI commands 174, and the models 176. The AI algorithms 172 may be executed by the server processor 126 to evaluate the audio data and/or the image data and/or perform one or more of the communication operations 137 in accordance with one or more models 176. Further, the AI algorithms 172 may be configured to interpret and transform the audio data, the image data, and/or the text data into structured data sets and be subsequently stored as files or tables. The AI algorithms 172 may cleanse, normalize raw data, and derive intermediate data to generate uniform data in terms of encoding, format, and data types. The AI algorithms 172 may be executed to run user queries and advanced analytical tools on the structured data. The AI algorithms 172 may be one or more machine learning algorithms configured to process the input data 152 as part of one or more training operations. The AI algorithms 172 may be configured to perform one or more operations aided by neural networks configured to provide association and/or connections between one or more data elements and data records. The neural networks may be equipped with one or more dedicated processors and/or memory storages distributed over multiple processing nodes. Each processing node may be a device configured to provide specialized content analysis in association with an input. In some embodiments, the AI algorithms 172 encompass various techniques, including supervised learning (e.g., trained on labeled data), unsupervised learning (e.g., analyzing unlabeled data), reinforcement learning (e.g., learning through trial and error), and deep learning (e.g., using complex models with hidden layers) among others. The AI algorithms 172 may be trained to perform one or more specialized analyses. The AI commands 174 may be one or more commands generated using one or more AI algorithms 172. The AI commands 174 may be configured to be one or more updates to the instructions 132. The AI commands 174 may be control commands, data signals, and/or configuration triggers configured to cause one or more elements stored in the server 102, the workspace devices 105, and/or the user devices 106. The models 176 may be one or more training protocols and/or structures to perform one or more operations in the system 100. The models 176 may be one or more instruction sets trained and/or created using the AI algorithms 172. The models 176 may be trained on a set of data to recognize certain patterns and/or make certain decisions autonomously. The models 176 may be configured to apply different AI algorithms 172 to relevant data inputs to achieve target tasks and/or outputs. In some embodiments, the models 176 may be defined by an ability to autonomously make decisions or predictions.

### Network

The network 110 facilitates communication between and amongst the various devices of the system 100. The network 110 may be any suitable network operable to facilitate communication between the server 102, the workspace devices 105, and the user devices 106 of the system 100. The network 110 may include any interconnecting system capable of transmitting audio, video, signals, data, data packets, messages, or any combination of the preceding. The network 110 may include all or a portion of a public switched telephone network (PSTN), a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the devices.

### Workspace Devices

In one or more embodiments, each of the workspace devices 105 (e.g., the workspace devices 105a-105d) may be any computing device configured to communicate with other devices, such as the server 102, other workspace devices 105 in additional workspace device groups 111, the user devices 106 in the user device group 113, other user devices 106 in additional user devices 106, databases, and the like in the system 100. Each of the workspace devices 105 may be configured to perform specific functions described herein and interact with one or more workspace devices 105b-105d in the user device group 113. Examples of the workspace devices 105 comprise, but are not limited to, a laptop, a computer, a smartphone, a tablet, a smart device, an IoT device, a simulated reality device, an augmented reality device, or any other suitable type of device. In this regard, each of the workspace devices 105 may be associated with one or more specific roles within an organization. Further, each of the workspace devices 105 may comprise access and/or connectivity to one or more elements of the messaging network in accordance with corresponding device roles.

The workspace devices 105 may be hardware configured to create, transmit, and/or receive information. The workspace devices 105 may be configured to receive inputs from a user, process the inputs, and generate data information or command information in response. The data information may include documents or files generated using a user interface. The command information may include input selections/commands triggered by a user using a peripheral component or one or more device peripherals 184 (i.e., a keyboard) or an integrated input system (i.e., a touchscreen presenting a user interface). The workspace devices 105 may be communicatively coupled to the server 102 via a network connection (i.e., one or more of the device interfaces 182). The workspace devices 105 may transmit and receive data information, command information, or a combination of both to and from the server 102 via the device interfaces 182. In one or more embodiments, the workspace devices 105 is configured to exchange data, commands, and signaling with the server 102. In some embodiments, the workspace devices 105 are configured to trigger the start of one or more communication operations. The workspace devices 105 may be configured to trigger network devices to perform one or more communication operations. In one or more embodiments, while FIG. 1 shows the workspace device 105b, the workspace device 105c, and the workspace device 105d, a given workspace device group 111 may comprise less or more workspace devices 105.

In one or more embodiments, referring to the workspace device 105a as a non-limiting example of the workspace devices 105, the workspace device 105a may comprise one or more device interfaces 182, one or more device peripherals 184, a device processor 186, the device databases 188, and a device memory 190. The device interfaces 182 may be any suitable hardware or software (e.g., executed by hardware) to facilitate any suitable type of communication in wireless or wired connections. These connections may comprise, but not be limited to, all or a portion of network connections coupled to additional workspace devices 105b-105d, the server 102, the user devices 106, the Internet, an Intranet, a private network, a public network, a peer-to-peer network, the public switched telephone network, a cellular network, a LAN, a MAN, a WAN, and a satellite network. The device interfaces 182 may be configured to support any suitable type of communication protocol.

In one or more embodiments, the one or more device peripherals 184 may comprise audio devices (e.g., speaker, microphones, and the like), input devices (e.g., keyboard, mouse, and the like), or any suitable electronic component that may provide a modifying or triggering input to the workspace device 105a. For example, the one or more device peripherals 184 may be speakers configured to release audio signals (e.g., voice signals or commands) during media playback operations. In another example, the one or more device peripherals 184 may be microphones configured to capture audio signals from the agent 112a. In one or more embodiments, the one or more device peripherals 184 may be configured to operate continuously, at predetermined time periods or intervals, or on-demand.

The device processor 186 may comprise one or more processors communicatively coupled to and in signal communication with the device interfaces 182, the device peripherals 184, the device databases 188, and the device memory 190. The device processor 186 is any electronic circuitry, including, but not limited to, state machines, one or more CPU chips, logic units, cores (e.g., a multi-core processor), FPGAs, ASICs, or DSPs. The device processor 186 may be a programmable logic device, a microcontroller, a microprocessor, or any suitable combination of the preceding. The one or more processors in the device processor 186 are configured to process data and may be implemented in hardware or software executed by hardware. For example, the device processor 186 may be an 8-bit, a 16-bit, a 32-bit, a 64-bit, or any other suitable architecture. The device processor 186 comprises an ALU to perform arithmetic and logic operations, processor registers that supply operands to the ALU, and store the results of ALU operations, and a control unit that fetches software instructions such as device instructions 192 from the device memory 190 and executes the device instructions 192 by directing the coordinated operations of the ALU, registers, and other components via a device processing engine (not shown). The device processor 186 may be configured to execute various instructions. For example, the device processor 186 may be configured to execute the device instructions 192 to implement functions or perform operations disclosed herein, such as some or all of those described with respect to FIGS. 1-3B. In some embodiments, the functions described herein are implemented using logic units, FPGAs, ASICs, DSPs, or any other suitable hardware or electronic circuitry.

The device databases 188 may be one or more storage devices configured to perform one or more storage operations. The device databases 188 may be configured to perform one or more operations described in reference to the databases 118.

In one or more embodiments, the device memory 190 may be operable to store multiple local operation data and one or more local applications associated with the server 102. The local operation data may be data configured to enable one or more data processing operations such as those described in relation with the server 102. The local operation data may be partially or completely different from those comprised in the server memory 130. The local applications may be one or more of the services described in relation with the server 102. In some embodiments, the local applications may be partially or completely different from those comprised in the server memory 130. Further, the device memory 190 may be operable to store one or more device instructions 192, one or more intelligent recording tools 193, and one or more recording platforms 194.

The intelligent recording tools 193 may be one or more recording tools configured to record content in one or more electronic screens 183 in the workspace devices 105. The intelligent recording tools 193 may be configured to incorporate one or more of the capabilities described in reference to the server 102.

The recording platforms 194 may be one or more services 151 and/or applications in which the device interfaces 182 and/or the device peripherals 184 are caused to create digital video data and/or digital image data representative of content in an electronic screen 183.

### User Devices

In one or more embodiments, each of the user devices 106 (e.g., the user devices 106a-106c) may be any computing device configured to communicate with other devices, such as the server 102, the workspace device 105a, the workspace devices 105b-105d in the workspace device group 111, other user devices 106 in other user device groups 113, databases, and the like in the system 100. Each of the user devices 106 may be configured to perform specific functions described herein and interact with one or more user devices 106a-106c in the user device group 113. Examples of the user devices 106 comprise, but are not limited to, a laptop, a computer, a smartphone, a tablet, a smart device, an IoT device, a simulated reality device, an augmented reality device, or any other suitable type of device. The user devices 106 may comprise some of capabilities described in reference to the workspace device 105a. In some embodiments, while FIG. 1 shows the user device 106a, the user device 106b, and the user device 106c, a given user device group 113 may comprise less or more workspace devices 105.

### Operational Flow to Dynamically Reconstruct Content Portions of an Electronic Screen

### Recording

FIG. 2 shows an operational flow 200 in which the system 100 of FIG. 1 is configured to generate one or more intelligent recordings 161, in accordance with one or more embodiments. In FIG. 2, the operational flow 200 comprises multiple operations 202-232. The operational flow 200 may be performed between the server 102 and one or more entities (e.g., the user devices 106, network components, and/or the workspace devices 105 among others). The operational flow 200 may be performed between a user device 106a associated with a user 114a and an agent 112a associated with a workspace device 105a. The operational flow 200 shows the operations 202-232 performed by an intelligent recording worker manager 240, a contextualized random frame organizer 250, a frame sequence metadata validator 262, an SOR entity matcher 264, a contextual change observer 266, an audit frame detector 270, an intelligent recorder 272, and an audit frame collector 274.

In one or more embodiments, the intelligent recording worker manager 240, the contextualized random frame organizer 250, the frame sequence metadata validator 262, the SOR entity matcher 264, the contextual change observer 266, the audit frame detector 270, the intelligent recorder 272, and the audit frame collector 274 may be one or more elements and/or electronic components comprised in the server 102 and/or one or more of the workspace devices 105.

The operational flow 200 may start at operation 202, where an intelligent recording worker manager 240 is configured to receive one or more annotated frames 143. Herein, original (e.g., raw) and annotated frames 143 may be provided as an input to the intelligent recording worker manager 240. At operation 204, the intelligent recording worker manager 240 is configured to transmit information to the SOR 135a. At operation 208, the intelligent recording worker manager 240 is configured to exchange information with the SOR 135b. At operation 210, the intelligent recording worker manager 240 is configured to exchange information with the SOR 135c. The intelligent recording worker manager 240 may be configured to determine annotated frames 143 associated with multiple SORs 135. The intelligent recording worker manager 240 is configured to create multiple worker nodes based on a number of screen recording systems. The intelligent recording worker manager 240 may be configured to record processing status and worker status associated with each of the SORs 135a-135c.

At operation 212, the SOR 135a is configured to transmit information to the frame sequence metadata validator 262. At operation 214, the frame sequence metadata validator 262 transmits information to the audit frame detector 270. The SOR 135a is configured to electronically divide one or more annotated frames 143 into one or more content portions 104. The annotated frames 143 being associated with one or more screen recordings. Herein, the frame sequence metadata validator 262 is configured to organize the metadata 146 from the annotated frames 143 based on the timestamps 144 content information (e.g., the labels 147) in the content portions 104. The frame sequence metadata validator 262 is configured to process the metadata 146 of the annotated frames 143 and attempts to arrange the annotated frames 143 in a sequence in accordance with a recording order 159 based on the timestamps 144. At operation 216, the SOR 135a is configured to transmit information to the SOR entity matcher 264. At operation 218, the SOR entity matcher 264 is configured to transmit information to the audit frame detector 270. The SOR entity matcher 264 may be configured to determine one or more query types 134 in the content portions 104 based on the information in the labels 147. The SOR entity matcher 264 may be configured to determine intent 164 of one or more communication queries 133 and relate each query and response along with the SOR 135a. If an annotated frame 143 is determined to be logically unrelated to other frames in a same sequence, the frame is labeled for an audit. At operation 220, the SOR 135a is configured to transmit information to the contextual change observer 266. At operation 222, the contextual change observer 266 is configured to transmit information to the audit frame detector 270. The contextual change observer 266 is configured to analyze and relate all the different frames from the SORs 135 and validate a contextual sequence of the frames. If the contextual change observer 266 determines any discrepancy in the context, then frames including discrepancies may be tagged for further review.

At operation 224, the audit frame detector 270 transmits information to the intelligent recorder 272. The audit frame detector 270 may be configured to create a sequence and classify the frames as selected frames comprising selected portions 160 or audit frames comprising audit portions 162. The frames may be organized into a recording order 159. At operation 226, the intelligent recorder 272 is configured to transmit information to the audit frame collector 274. The intelligent recorder 272 may be configured to remove frames that the audit frame detector 270 classified as auditable and processes remaining original frames and convert the frames into a recorded version (e.g., an intelligent recording 161). At operation 228, the audit frame collector 274 is configured to transmit information feedback to the SOR 135a. The audit frame collector 274 may be configured to collect the audit frames and/or audit portions 162 and to be handled by a one of the additional SORs 135. At operation 230, the intelligent recording worker manager 240 is configured to receive information from the SOR 135a. The intelligent recording worker manager 240 may be configured to review the audit frames and/or the audit portions 162 and assign the audit frames and/or the audit portions 162 to other SORs 135 to see whether the audit frames and/or the audit portions 162 are relevant to additional recordings.

At operation 232, the intelligent recording worker manager 240 may be configured to transmit one or more audit portions 162. The intelligent recording worker manager 240 may be configured to store the audit frames and/or the audit portions 160 in an audit trail. Herein, if other SORs 135 determine whether the audit frames and/or the audit portions 162 are relevant, then the SORs 135 may be marked as processed status and unprocessed state frames may be further analyzed to take an action on an additional intelligent recording 161.

At operation 234, the SOR 135a is configured to receive information from a contextualized random frame organizer 250. The contextualized random frame organizer 250 may be configured to perform additional attempts to fit the audit frames and/or the audit portions 162 into one or more existing intelligent recordings 161.

In one or more embodiments, one of the workspace devices 105 (e.g., the workspace device 105a) may be configured to create one or more working nodes (e.g., SORs 135). The SORs 135 may be configured to generate one or more recordings of one or more electronic screens 183 and/or one or more specific communication queries 133 using at least one screen recording system. In some embodiments, each SOR 135 may be associated with a screen recording system. Herein the workspace device 105a and/or the server 102 may be configured to perform one or more of the operations described in reference to operations 202-234. The workspace device 105a may be configured to communicate with one or more user devices 106 via the server 102 and/or the network 110. The workspace device 105a may be configured to record information exchanges with the user device 106.

In one or more embodiments, the server 102 and/or the workspace device 105a may be configured to determine frames to record versus not-record and frames to keep together. The server 102 and/or the workspace device 105a may be configured to account for one or more initiatives (e.g., regulatory initiated-to record electronic screens 183 that agents 112 reference to serve users 114) and handle with a single agent 112 serving multiple users 114 (e.g., referencing multiple SORs 135 based on communication queries 133). The server 102 and/or the workspace device 105a may be configured to account for situations in which a workspace device 105a performing communication operations 137 with multiple user devices 106 (e.g., user device 106a, user device 106b, and user device 106c) on multiple electronic screens 183. The agent 112a associated with the workspace device 105a may cause the workspace device 105a to switch SORs 135 to reference user data. Herein, intelligent recordings 161 associated with specific communication queries 133 may be generated even if, while performing multiple operations in the workspace device 105a, the agent 112a accidently navigates between SOR 135b related to user device 106b while communicating with the user device 106a.

In some embodiments, the server 102 and/or the workspace device 105a are configured to inhibit, reduce, and/or eliminate electronic recordings comprising unintentional navigation by inhibiting and/or preventing wrong recordings when agent 112 accidentally hovers on wrong electronic screens 183 (e.g., recording electronic screen 183 of SOR 135b while attending user device 106a. Further, the server 102 and/or the workspace device 105a are configured to inhibit, reduce, and/or eliminate electronic recordings comprising incorrect intentional navigation by inhibiting and/or preventing wrong recordings showing data associated with unrelated user devices 106 (e.g., as SORs 135 may be similar for same communication queries 133 and agents 112 may have many parallel electronic queries opened). Herein, the server 102 and/or the workspace device 105a may be configured to generate a warning and/or an alert.

### Example Process to Dynamically Reconstruct Portions of an Electronic Screen Recording

FIGS. 3A and 3B illustrates an example flowchart of a process 300 configured to dynamically reconstruct portions of an electronic screen recording, in accordance with one or more embodiments. Modifications, additions, or omissions may be made to the process 300. The process 300 may comprise more, fewer, or other operations than those shown in FIGS. 3A and 3B. For example, operations may be performed in parallel or in any suitable order. While at times discussed as the server 102, the workspace devices 105, or components of any of thereof performing operations described in operations 302-364 in the process 300, any suitable system or components of the system 100 may perform one or more operations of the process 300. For example, one or more operations of the process 300 may be implemented, at least in part, in the form of instructions 132 of FIG. 1, stored on non-transitory, tangible, machine-readable media (e.g., a non-transitory computer-readable medium such as memory 130 of FIG. 1) that when run by one or more processors (e.g., the server processor 128 of FIG. 1) may cause the one or more processors to perform operations described in operations 302-364.

The process 300 starts at operation 302, where the server 102 is configured to obtain one or more annotated frames 143 from a data packet. The annotated frames 143 may be obtained from a data stream packet 142. The data stream packet 142 may be intercepted from one or more data streams. The data stream packet 142 may be received and/or obtained as part of one or more data exchange operations. The data stream packet 142 may be configured to include multiple annotated frames 143 previously generated from training materials. The data stream packet 142 may comprise one or more annotated frames 143. Each of the annotated frames 143 may comprise a corresponding timestamp 144, one or more content portions 104, corresponding metadata 146, and/or one or more labels 147. For example, intercepted and/or obtained data stream packets 142 may comprise a first annotated frame 143, a second annotated frame 143, and a third annotated frame 143. The first annotated frame, the second annotated frame, and the third annotated frame may correspond to an electronic recording of an electronic screen 183 (e.g., one or more server I/O interfaces 120 and/or one or more device interfaces 182) associated with a workspace device 105. The first annotated frame 143 may comprise a first timestamp 144, first content portions 104, and first metadata 146. The second annotated frame 143 may comprise a second timestamp 144, second content portions 104, and second metadata 146. The third annotated frame 143 may comprise a third timestamp 144, third content portions 104, and third metadata 146.

At operation 304, the server 102 is configured to electronically divide the first annotated frame 143 into first content portions 104, the second annotated frame 143 into second content portions 104, and the third annotated frame 143 into third content portions 104. At operation 306, the server 102 is configured to electronically extract first labels 147 from the first annotated frame 143, second labels 147 from the second annotated frame 143, and third labels 147 from the third annotated frame 143. In particular, the labels 147 may be obtained from metadata 146 associated with a specific annotated frame 143. The server 102 may be configured to electronically extract the first labels 147 from the first metadata 146, the second labels 147 from the second metadata 146, and the third labels 147 from the third metadata 146. Each of the first labels 147 may correspond to one of the first content portions 104. Each of the second labels 147 may correspond to one of the second content portions 104. Each of the third labels 147 may correspond to one of the third content portions 104. At operation 308, the server 102 is configured to train an artificial intelligence algorithm 172 based on input data 152 representative of historical data 153 associated with possible static layouts 154 found in an electronic screen 183 and expected dynamic content 155 to be shown in the electronic screen 183. At operation 310, the server 102 is configured to arrange, using the trained artificial intelligence algorithm 172, the first annotated frame 143, the second annotated frame 143, and the third annotated frame 143 in in a recording order 159 based on corresponding timestamps 144. Herein, the server 102 may be configured to arrange, using the trained artificial intelligence algorithm 172, the first annotated frame 143, the second annotated frame 143, and the third annotated frame 143 in in the recording order 159 based on the first timestamp 144, the second timestamp 144, and the third timestamp 144.

At operation 312, the server 102 is configured to locate, using the trained artificial intelligence algorithm 172, a reference label 147 in the first labels 147, the second labels 147, and the third labels 147 matching a query type 134. The server 102 may be configured to locate, using the trained artificial intelligence algorithm 172, the reference label 147 in the first labels 147, the second labels 147, and the third labels 147 matching the query type 134 handled by the workspace device 105 while the electronic recording of the electronic screen 183 was performed. At operation 314, the server 102 is configured to isolate, using the trained artificial intelligence algorithm 172, selected portions 160 of the content portions 104 matching the reference label 147 in the annotated frames 143. Herein, the server 102 may be configured to isolate, using the trained artificial intelligence algorithm 172, a first selected portion 160 of the first content portions 104 matching the reference label 147 in the first annotated frame 143, a second selected portion 160 of the second content portions 104 matching the reference label 147 in the second annotated frame 143, and a third selected portion 160 of the third content portions 104 matching the reference label 147 in the third annotated frame 143. At operation 316, the server 102 is configured to electronically separate, using the trained artificial intelligence algorithm 172, the selected portions 160 from the corresponding content portions 104. The server 102 may be configured to electronically separate, using the trained artificial intelligence algorithm 172, the first selected portion 160 from the first content portions 104, the second selected portion 160 from the second content portions 104, and the third selected portion 160 from the third content portions 104.

At operation 318, the server 102 is configured to create, using the trained artificial intelligence algorithm 172, tracking parameters 163 may be configured to track content changes (e.g., contextual changes 141) in the selected portions 160 based on the query type 134. The server 102 may be configured to create, using the trained artificial intelligence algorithm 172, the tracking parameters 163 configured to track content changes in the first selected portion 160, the second selected portion 160, and the third selected portion 160 based on the query type 134. At operation 320, the server 102 is configured to track, in conjunction with the plurality of tracking parameters 163, content change between the selected portions 160. The server 102 may be configured to track, in conjunction with the plurality of tracking parameters 163, a first content change between the first selected portion 160 and the second selected portion 160 and a second content change from the second selected portion 160 to the third selected portion 160. At operation 322, the server 102 is configured to derive, using the trained artificial intelligence algorithm 172, intents 164 associated with the content changes. For example, the server 102 may be configured to derive, using the trained artificial intelligence algorithm 172, a first intent 164 associated with the first content change and a second intent 164 associated with the second content change.

At operation 330, the server 102 is configured to determine whether the first intent 164 matches the query type 134. The server 102 may be configured to determine, using the trained artificial intelligence algorithm 172, whether the first intent 164 logically matches the query type 134. If the server 102 determines that the first intent 164 does not match the query type 134 (e.g., NO), the process 300 proceeds to operation 332 and operation 334. At operation 332, the server 102 is configured to electronically replace the reference label 147 in the second selected portion 160 with an audit label 147. At operation 334, the server 102 is configured to store second selected portion 160 associated with audit label 147 in an audit database (e.g., the databases 118). If the server 102 determines that first intent 164 matches the query type 134 (e.g., YES), the process 300 proceeds to operation 342. At operation 342, the server 102 is configured to approve, using the trained artificial intelligence algorithm 172, first selected portion 160 and second selected portion 160 to a recording (e.g., for an intelligent recording 161).

At operation 350, the server 102 is configured to determine whether the second intent 164 matches the query type 134. The server 102 may be configured to determine, using the trained artificial intelligence algorithm 172, whether the second intent 164 logically matches the query type 134. If the server 102 determines that the second intent 164 does not match the query type 134 (e.g., NO), the process 300 proceeds to operation 352 and operation 354. At operation 352, the server 102 is configured to electronically replace the reference label 147 in the third selected portion 160 with audit label 147. At operation 354, the server 102 is configured to store third selected portion 160 associated with audit label 147 in the audit database. If the server 102 determines that first intent 164 matches the query type 134 (e.g., YES), the process 300 proceeds to operation 362 and operation 364.

The process 300 may end at operation 362 and operation 364, where the server 102 may be configured to generate an intelligent recording 161 based on segmented portions of one or more annotated frames 143 from a data stream packet 142. At operation 362, the server 102 is configured to approve, using the trained artificial intelligence algorithm 172, third selected portion 160 to the recording. At operation 364, the server 102 is configured to create, using the trained artificial intelligence algorithm 172, the intelligent recording 161 comprising the selected portions 160. In response to determining that the second intent 164 logically matches the query type 134, the server 102 may be configured to create, using the trained artificial intelligence algorithm 172, the intelligent recording 161 comprising the first selected portion 160, the second selected portion 160, and the third selected portion 160.

In one or more embodiments, the server 102 may be configured to determine whether any of the selected portions 160 are associated with additional selected portions 160 based on contextual changes 141. In this regard, the server 102 may be configured to determine, using the trained artificial intelligence algorithm 172, whether the selected portions 160 are relevant to an intelligent recording 161. If a selected portion 160 were to be considered to comprise changes that are not logical in accordance with a query type 134, the server 102 may be configured to label such selected portions 160 as an audit portion 160. Audit portions 162 may be excluded from being included in the intelligent recording 161. In some embodiments, certain audit portions 162 may be evaluated to be added to other intelligent recording 161. In other embodiments, certain audit portions 162 may be evaluated to be discarded and not to be added to other intelligent recording 161.

In one or more embodiments, prior to the process 300, raw frames of a recorded video (e.g., in an original format) may be annotated to generate the annotated frames 143 using the trained artificial intelligence algorithm 172. In particular, the AI algorithms 172 may be trained to associate agent actions to specific topics. Herein, the system 100 may be configured to collect all recorded videos in a database, divide the recordings into individual frames, split the frames in sections with multiple portions, and annotate these sections with metadata 146 referencing topics and/or queries associated with a situation handled by an agent 112 when the video was recorded.

In some embodiments, the system 100 may be configured to convert a video recording into multiple frames. Each frame may be processed to extract frame layout information (e.g., a frame header, a chat box, an agent chat frame style, communication links, layout specific elements, and the like). The system 100 may be configured to manually annotate frames with metadata 146 comprising labels 147 that reference multiple aspects in the content portions 104. The updated frames with the metadata 146 and the labels 147 may be evaluated to determine text characters using an OCR tool. The OCR tool may be configured to electronically extract text characters from the updated frames. At this stage, the system 100 may be configured to identify relationships between words formed by the text characters using existing models 176 and/or dictionary libraries. The identified relationships, the metadata 146 and labels 147 may be segmented for each content portion such that each content portion 104 comprises individual metadata 146 and individual labels 147. In some embodiments, the system 100 comprises a custom entity extractor configured to isolate sensitive and/or personal information in the frames and electronically remove the isolated sensitive and/or personal information in each frame in accordance with the rules and policies 148. The custom entity extractor may be configured to reannotate the labels 147 to associate portions of the content portions 104 with specific identifying concepts (e.g., person information, dates, or origin address of a communication operation 137). Herein, the custom entity extractor may be configured to mask extracted sensitive and/or personal data in the raw version of the frames and the annotated version of the frame.

### Scope of the Disclosure

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory operable to store:
a plurality of annotated frames corresponding to an electronic recording of an electronic screen associated with a workspace device, wherein:
the plurality of annotated frames comprises a first annotated frame, a second annotated frame, and a third annotated frame;
the first annotated frame comprises a first timestamp, a first plurality of content portions, and first metadata;
the second annotated frame comprises a second timestamp, a second plurality of content portions, and second metadata; and
the third annotated frame comprises a third timestamp, a third plurality of content portions, and third metadata; and
at least one processor communicatively coupled to the memory and configured to:
electronically divide the first annotated frame into the first plurality of content portions, the second annotated frame into the second plurality of content portions, and the third annotated frame into the third plurality of content portions;
electronically extract a first plurality of labels from the first metadata, a second plurality of labels from the second metadata, and a third plurality of labels from the third metadata, wherein:
each of the first plurality of labels correspond to one the first plurality of content portions;
each of the second plurality of labels correspond to one of the second plurality of content portions; and
each of the third plurality of labels correspond to one of the third plurality of content portions;
train an artificial intelligence algorithm based at least in part upon input data representative of historical data associated with possible static layouts found in the electronic screen and expected dynamic content to be shown in the electronic screen;
arrange, using the trained artificial intelligence algorithm, the first annotated frame, the second annotated frame, and the third annotated frame in in a recording order based on the first timestamp, the second timestamp, and the third timestamp;
locate, using the trained artificial intelligence algorithm, a reference label in the first plurality of labels, the second plurality of labels, and the third plurality of labels matching a query type handled by the workspace device while the electronic recording of the electronic screen was performed;
isolate, using the trained artificial intelligence algorithm, a first selected portion of the first plurality of content portions matching the reference label in the first annotated frame, a second selected portion of the second plurality of content portions matching the reference label in the second annotated frame, and a third selected portion of the third plurality of content portions matching the reference label in the third annotated frame;
electronically separate, using the trained artificial intelligence algorithm, the first selected portion from the first plurality of content portions, the second selected portion from the second plurality of content portions, and the third selected portion from the third plurality of content portions;
create, using the trained artificial intelligence algorithm, a plurality of tracking parameters configured to track content changes in the first selected portion, the second selected portion, and the third selected portion based on the query type;
track, in conjunction with the plurality of tracking parameters, a first content change between the first selected portion and the second selected portion and a second content change from the second selected portion to the third selected portion;
derive, using the trained artificial intelligence algorithm, a first intent associated with the first content change and a second intent associated with the second content change;
determine, using the trained artificial intelligence algorithm, whether the first intent logically matches the query type;
in response to determining that the first intent logically matches the query type, determine, using the trained artificial intelligence algorithm, whether the second intent logically matches the query type; and
in response to determining that the second intent logically matches the query type, create, using the trained artificial intelligence algorithm, an intelligent recording comprising the first selected portion, the second selected portion, and the third selected portion.

2. The system of claim 1, wherein the processor is further configured to:
locate, using the trained artificial intelligence algorithm, an additional reference label in the first plurality of labels, the second plurality of labels, and the third plurality of labels matching an additional query type handled by the workspace device while the electronic recording of the electronic screen was performed;
isolate, using the trained artificial intelligence algorithm, a fourth selected portion of the first plurality of content portions matching the reference label in the first annotated frame, a fifth selected portion of the second plurality of content portions matching the reference label in the second annotated frame, and a sixth selected portion of the third plurality of content portions matching the reference label in the third annotated frame;
electronically separate, using the trained artificial intelligence algorithm, the fourth selected portion from the first plurality of content portions, the fifth selected portion from the second plurality of content portions, and the sixth selected portion from the third plurality of content portions;
create, using the trained artificial intelligence algorithm, an additional plurality of tracking parameters configured to track additional content changes in the fourth selected portion, the fifth selected portion, and the sixth selected portion based on the additional query type;
track, in conjunction with the additional plurality of tracking parameters, a third content change between the fourth selected portion and the fifth selected portion, a fourth content change from the fifth selected portion to the sixth selected portion, and a fifth content change between the fourth selected portion and the sixth selected portion;
derive, using the trained artificial intelligence algorithm, a third intent associated with the third content change, a fourth intent associated with the fourth content change, and a fifth intent associated with the fifth content change;
determine, using the trained artificial intelligence algorithm, whether the third intent logically matches the additional query type;
in response to determining that the third intent does not logically match the additional query type, determine, using the trained artificial intelligence algorithm, whether the fourth intent logically matches the additional query type;
in response to determining that the fourth intent does not logically match the additional query type, determine, using the trained artificial intelligence algorithm, whether the fifth intent logically matches the additional query type;
determine, using the trained artificial intelligence algorithm, whether the second intent logically matches the additional query type; and
in response to determining that the fifth intent logically matches the additional query type, create, using the trained artificial intelligence algorithm, an additional intelligent recording comprising the fourth selected portion and the sixth selected portion.

3. The system of claim 2, wherein the processor is further configured to:
determine, using the trained artificial intelligence algorithm, whether the fifth selected portion is relevant to the first selected portion, the second selected portion, or the third selected portion; and
in response to determining that the fifth selected portion is logically related to the first selected portion, the second selected portion, or the third selected portion, modify the intelligent recording to comprise the first selected portion, the second selected portion, the third selected portion, and the fifth selected portion.

4. The system of claim 2, wherein the processor is further configured to:
determine, using the trained artificial intelligence algorithm, whether the fifth selected portion is relevant to the first selected portion, the second selected portion, or the third selected portion; and
in response to determining that the fifth selected portion is not logically related to the first selected portion, the second selected portion, or the third selected portion, discard the fifth selected portion.

5. The system of claim 2, wherein the processor is further configured to:
electronically replace the additional reference label in the fifth selected portion with an audit label; and
store the fifth selected portion associated with the audit label in an audit database.

6. The system of claim 2, wherein:
the query type is different to the additional query type.

7. The system of claim 1, wherein:
the first annotated frame, the second annotated frame, and the third annotated frame are not consecutive frames.

8. The system of claim 1, wherein, in conjunction with training the artificial intelligence algorithm based at least in part upon the input data, the processor is further configured to:
collect a set of digital images from a database, the set of digital images comprising layout elements expected to be found in the electronic screen during a recording session;
transform each digital image in the set of digital images in accordance with a randomized condition;
create a first training set comprising the set of digital images, a transformed version of the set of digital images, and a set of content images representing the historical data associated with previous queries handled by the workspace device;
train, in a first stage, the artificial intelligence algorithm using the first training set;
create a second training set for a second stage of training comprising the first training set and a set of digital contentless images representing the historical data associated with previously incorrect queries handled by the workspace device;
train, in a second stage, the artificial intelligence algorithm using the second training set; and
in response to training the artificial intelligence algorithm in the second stage, create, using the trained artificial intelligence algorithm, the input data representative of the historical data associated with the possible static layouts found in the electronic screen.

9. A method, comprising:
electronically dividing a first annotated frame into a first plurality of content portions, a second annotated frame into a second plurality of content portions, and a third annotated frame into a third plurality of content portions, wherein:
the first annotated frame, the second annotated frame, and the third annotated frame being comprised in a plurality of annotated frames corresponding to an electronic recording of an electronic screen associated with a workspace device;
the first annotated frame comprises a first timestamp, the first plurality of content portions, and first metadata;
the second annotated frame comprises a second timestamp, the second plurality of content portions, and second metadata; and
the third annotated frame comprises a third timestamp, the third plurality of content portions, and third metadata;
electronically extracting a first plurality of labels from the first metadata, a second plurality of labels from the second metadata, and a third plurality of labels from the third metadata, wherein:
each of the first plurality of labels correspond to one the first plurality of content portions;
each of the second plurality of labels correspond to one of the second plurality of content portions; and
each of the third plurality of labels correspond to one of the third plurality of content portions;
training an artificial intelligence algorithm based at least in part upon input data representative of historical data associated with possible static layouts found in the electronic screen and expected dynamic content to be shown in the electronic screen;
arranging, using the trained artificial intelligence algorithm, the first annotated frame, the second annotated frame, and the third annotated frame in in a recording order based on the first timestamp, the second timestamp, and the third timestamp;
locating, using the trained artificial intelligence algorithm, a reference label in the first plurality of labels, the second plurality of labels, and the third plurality of labels matching a query type handled by the workspace device while the electronic recording of the electronic screen was performed;
isolating, using the trained artificial intelligence algorithm, a first selected portion of the first plurality of content portions matching the reference label in the first annotated frame, a second selected portion of the second plurality of content portions matching the reference label in the second annotated frame, and a third selected portion of the third plurality of content portions matching the reference label in the third annotated frame;
electronically separating, using the trained artificial intelligence algorithm, the first selected portion from the first plurality of content portions, the second selected portion from the second plurality of content portions, and the third selected portion from the third plurality of content portions;
creating, using the trained artificial intelligence algorithm, a plurality of tracking parameters configured to track content changes in the first selected portion, the second selected portion, and the third selected portion based on the query type;
tracking, in conjunction with the plurality of tracking parameters, a first content change between the first selected portion and the second selected portion and a second content change from the second selected portion to the third selected portion;
deriving, using the trained artificial intelligence algorithm, a first intent associated with the first content change and a second intent associated with the second content change;
determining, using the trained artificial intelligence algorithm, whether the first intent logically matches the query type;
in response to determining that the first intent logically matches the query type, determining, using the trained artificial intelligence algorithm, whether the second intent logically matches the query type; and
in response to determining that the second intent logically matches the query type, creating, using the trained artificial intelligence algorithm, an intelligent recording comprising the first selected portion, the second selected portion, and the third selected portion.

10. The method of claim 9, further comprising:
locating, using the trained artificial intelligence algorithm, an additional reference label in the first plurality of labels, the second plurality of labels, and the third plurality of labels matching an additional query type handled by the workspace device while the electronic recording of the electronic screen was performed;
isolating, using the trained artificial intelligence algorithm, a fourth selected portion of the first plurality of content portions matching the reference label in the first annotated frame, a fifth selected portion of the second plurality of content portions matching the reference label in the second annotated frame, and a sixth selected portion of the third plurality of content portions matching the reference label in the third annotated frame;
electronically separating, using the trained artificial intelligence algorithm, the fourth selected portion from the first plurality of content portions, the fifth selected portion from the second plurality of content portions, and the sixth selected portion from the third plurality of content portions;
creating, using the trained artificial intelligence algorithm, an additional plurality of tracking parameters configured to track additional content changes in the fourth selected portion, the fifth selected portion, and the sixth selected portion based on the additional query type;
tracking, in conjunction with the additional plurality of tracking parameters, a third content change between the fourth selected portion and the fifth selected portion, a fourth content change from the fifth selected portion to the sixth selected portion, and a fifth content change between the fourth selected portion and the sixth selected portion;
deriving, using the trained artificial intelligence algorithm, a third intent associated with the third content change, a fourth intent associated with the fourth content change, and a fifth intent associated with the fifth content change;
determining, using the trained artificial intelligence algorithm, whether the third intent logically matches the additional query type;
in response to determining that the third intent does not logically match the additional query type, determining, using the trained artificial intelligence algorithm, whether the fourth intent logically matches the additional query type;
in response to determining that the fourth intent does not logically match the additional query type, determining, using the trained artificial intelligence algorithm, whether the fifth intent logically matches the additional query type;
determining, using the trained artificial intelligence algorithm, whether the second intent logically matches the additional query type; and
in response to determining that the fifth intent logically matches the additional query type, creating, using the trained artificial intelligence algorithm, an additional intelligent recording comprising the fourth selected portion and the sixth selected portion.

11. The method of claim 10, further comprising:
determining, using the trained artificial intelligence algorithm, whether the fifth selected portion is relevant to the first selected portion, the second selected portion, or the third selected portion; and
in response to determining that the fifth selected portion is logically related to the first selected portion, the second selected portion, or the third selected portion, modifying the intelligent recording to comprise the first selected portion, the second selected portion, the third selected portion, and the fifth selected portion.

12. The method of claim 10, further comprising:
determining, using the trained artificial intelligence algorithm, whether the fifth selected portion is relevant to the first selected portion, the second selected portion, or the third selected portion; and
in response to determining that the fifth selected portion is not logically related to the first selected portion, the second selected portion, or the third selected portion, discarding the fifth selected portion.

13. The method of claim 10, further comprising:
electronically replacing the additional reference label in the fifth selected portion with an audit label; and
storing the fifth selected portion associated with the audit label in an audit database.

14. The method of claim 10, wherein:
the query type is different to the additional query type.

15. The method of claim 9, wherein:
the first annotated frame, the second annotated frame, and the third annotated frame are not consecutive frames.

16. A non-transitory computer-readable medium storing instructions that when executed by a processor cause the processor to:
electronically divide a first annotated frame into a first plurality of content portions, a second annotated frame into a second plurality of content portions, and a third annotated frame into a third plurality of content portions, wherein:
the first annotated frame, the second annotated frame, and the third annotated frame being comprised in a plurality of annotated frames corresponding to an electronic recording of an electronic screen associated with a workspace device;
the first annotated frame comprises a first timestamp, the first plurality of content portions, and first metadata;
the second annotated frame comprises a second timestamp, the second plurality of content portions, and second metadata; and
the third annotated frame comprises a third timestamp, the third plurality of content portions, and third metadata;
electronically extract a first plurality of labels from the first metadata, a second plurality of labels from the second metadata, and a third plurality of labels from the third metadata, wherein:
each of the first plurality of labels correspond to one the first plurality of content portions;
each of the second plurality of labels correspond to one of the second plurality of content portions; and
each of the third plurality of labels correspond to one of the third plurality of content portions;
train an artificial intelligence algorithm based at least in part upon input data representative of historical data associated with possible static layouts found in the electronic screen and expected dynamic content to be shown in the electronic screen;
arrange, using the trained artificial intelligence algorithm, the first annotated frame, the second annotated frame, and the third annotated frame in in a recording order based on the first timestamp, the second timestamp, and the third timestamp;
locate, using the trained artificial intelligence algorithm, a reference label in the first plurality of labels, the second plurality of labels, and the third plurality of labels matching a query type handled by the workspace device while the electronic recording of the electronic screen was performed;
isolate, using the trained artificial intelligence algorithm, a first selected portion of the first plurality of content portions matching the reference label in the first annotated frame, a second selected portion of the second plurality of content portions matching the reference label in the second annotated frame, and a third selected portion of the third plurality of content portions matching the reference label in the third annotated frame;
electronically separate, using the trained artificial intelligence algorithm, the first selected portion from the first plurality of content portions, the second selected portion from the second plurality of content portions, and the third selected portion from the third plurality of content portions;
create, using the trained artificial intelligence algorithm, a plurality of tracking parameters configured to track content changes in the first selected portion, the second selected portion, and the third selected portion based on the query type;
track, in conjunction with the plurality of tracking parameters, a first content change between the first selected portion and the second selected portion and a second content change from the second selected portion to the third selected portion;
derive, using the trained artificial intelligence algorithm, a first intent associated with the first content change and a second intent associated with the second content change;
determine, using the trained artificial intelligence algorithm, whether the first intent logically matches the query type;
in response to determining that the first intent logically matches the query type, determine, using the trained artificial intelligence algorithm, whether the second intent logically matches the query type; and
in response to determining that the second intent logically matches the query type, create, using the trained artificial intelligence algorithm, an intelligent recording comprising the first selected portion, the second selected portion, and the third selected portion.

17. The non-transitory computer-readable medium of claim 16, wherein the instructions further cause the processor to:
locate, using the trained artificial intelligence algorithm, an additional reference label in the first plurality of labels, the second plurality of labels, and the third plurality of labels matching an additional query type handled by the workspace device while the electronic recording of the electronic screen was performed;
isolate, using the trained artificial intelligence algorithm, a fourth selected portion of the first plurality of content portions matching the reference label in the first annotated frame, a fifth selected portion of the second plurality of content portions matching the reference label in the second annotated frame, and a sixth selected portion of the third plurality of content portions matching the reference label in the third annotated frame;
electronically separate, using the trained artificial intelligence algorithm, the fourth selected portion from the first plurality of content portions, the fifth selected portion from the second plurality of content portions, and the sixth selected portion from the third plurality of content portions;
create, using the trained artificial intelligence algorithm, an additional plurality of tracking parameters configured to track additional content changes in the fourth selected portion, the fifth selected portion, and the sixth selected portion based on the additional query type;
track, in conjunction with the additional plurality of tracking parameters, a third content change between the fourth selected portion and the fifth selected portion, a fourth content change from the fifth selected portion to the sixth selected portion, and a fifth content change between the fourth selected portion and the sixth selected portion;
derive, using the trained artificial intelligence algorithm, a third intent associated with the third content change, a fourth intent associated with the fourth content change, and a fifth intent associated with the fifth content change;
determine, using the trained artificial intelligence algorithm, whether the third intent logically matches the additional query type;
in response to determining that the third intent does not logically match the additional query type, determine, using the trained artificial intelligence algorithm, whether the fourth intent logically matches the additional query type;
in response to determining that the fourth intent does not logically match the additional query type, determine, using the trained artificial intelligence algorithm, whether the fifth intent logically matches the additional query type;
determine, using the trained artificial intelligence algorithm, whether the second intent logically matches the additional query type; and
in response to determining that the fifth intent logically matches the additional query type, create, using the trained artificial intelligence algorithm, an additional intelligent recording comprising the fourth selected portion and the sixth selected portion.

18. The non-transitory computer-readable medium of claim 17, wherein the instructions further cause the processor to:
determine, using the trained artificial intelligence algorithm, whether the fifth selected portion is relevant to the first selected portion, the second selected portion, or the third selected portion; and
in response to determining that the fifth selected portion is logically related to the first selected portion, the second selected portion, or the third selected portion, modify the intelligent recording to comprise the first selected portion, the second selected portion, the third selected portion, and the fifth selected portion.

19. The non-transitory computer-readable medium of claim 17, wherein the instructions further cause the processor to:
determine, using the trained artificial intelligence algorithm, whether the fifth selected portion is relevant to the first selected portion, the second selected portion, or the third selected portion; and
in response to determining that the fifth selected portion is not logically related to the first selected portion, the second selected portion, or the third selected portion, discard the fifth selected portion.

20. The non-transitory computer-readable medium of claim 17, wherein the instructions further cause the processor to:
electronically replace the additional reference label in the fifth selected portion with an audit label; and
store the fifth selected portion associated with the audit label in an audit database.
